(19) United States
(12) Patent Application Publication
(10) Pub. No.: US 2024/0015807 A1
(43) Pub. Date: Jan. 11, 2024

(54) ASSISTED MULTI-LINK GUIDANCE FROM NETWORK ACCESS POINT

(71) Applicant: Cisco Technology, Inc., San Jose, CA (US)

(72) Inventors: Vinay SAINI, Bengaluru (IN); Jerome HENRY, Pittsboro, NC (US); Akram I. SHERIFF, San Jose, CA (US); Nagendra Kumar NAINAR, Morrisville, NC (US); Robert E. BARTON, Richmond (CA)

(21) Appl. No.: 18/176,999

(22) Filed: Mar. 1, 2023

(30) Foreign Application Priority Data
Jul. 11, 2022 (IN) 202241039811

(51) Int. Cl. H04W 76/10; H04W 72/02

(52) U.S. Cl. CPC H04W 76/10; H04W 72/02

(57) ABSTRACT

Disclosed are a system and a method for selecting an additional radio link from a second access point after a connection with a first access point has been established. The first and second access points cooperate with each other by sharing information about performance and available resources. They communicate this information to a multi-link non-AP MLD device requesting the additional radio link so that the non-AP MLD can make a selection that matches the needs of its request. Information about performance includes throughput, a delay between access points, and a delay between access points and a gateway connected to the access points.

### CROSS-REFERENCE TO RELATED APPLICATIONS

This application claims benefit of co-pending Indian provisional patent application Serial No. 2022/41039811, filed Jul. 11, 2022. The aforementioned related patent application is herein incorporated by reference in its entirety.

### TECHNICAL FIELD

Embodiments presented in this disclosure generally relate to wireless networking. More specifically, embodiments disclosed herein relate to multi-link access points providing guidance to a station coupled to the access points.

### BACKGROUND

Multi-link operations assume that a non-AP multi-link device (MLD)can use multiple concurrent radio links to communicate with different radio links of the same MLD access point (AP) or different MLD APs. The non-AP MLD has different stations (STAs), one per link, but a single interface to the upper layers of networking, allowing it to have the same non-AP MLD identity. However, the non-AP MLD has the burden of selecting an additional radio link but lacks the details regarding the network state of other available MLD APs. Thus, there is a need to help the non-AP MLD choose a link based on its requirements.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts a representative access point (AP) architecture.

FIG. 2 depicts two multi-link devices communicating over radio links, in an embodiment.

FIG. 3 depicts two APs coordinating with each other, in an embodiment.

FIG. 4 depicts two APs coordinating with each other, in an embodiment.

FIG. 5A depicts a flow of operations for a primary multi-link device, in an embodiment.

FIG. 5B depicts a flow of operations for a non-AP MLD, in an embodiment.

FIG. 6A depicts a flow of operations for multi-link AP coordination, in an embodiment.

FIG. 6B depicts a flow of operations for a non-AP MLD, in an embodiment.

FIG. 7A depicts a flow of operations for a multi-link device (MLD) group exchange function, in an embodiment.

FIG. 7B depicts a composite metric, in an embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

Overview

One embodiment presented in this disclosure is a method of aiding selection of at least one additional radio link. The method includes establishing a connection between a radio link between a first access point and a non-AP MLD device, obtaining a set of indicators for a plurality of radio links, where the set of indicators includes key performance indicators for each radio link and resources available via each radio link, forming a list of available radio links based on the key performance indicators and available resources, where the list of available radio links are those present on a second access point, receiving a request for at least one additional radio link from the non-AP MLD device, sending the list of available radio links to the non-AP MLD device, where the non-AP MLD device selects at least one additional radio link and makes a connection using the at least one additional radio link on the second access point.

Another embodiment presented in the disclosure is a system for aiding selection of at least one additional radio link. The system includes a first access point having multiple radio links, a second access point having multiple radio links and coupled to the first access point, and a non-AP MLD device having multiple radio links and coupled to the first access point and the second access point. The first access point is configured to: establish a connection using a radio link of the first access point and the non-AP MLD device; obtain a set of indicators for a plurality of radio links, where the set of indicators includes key performance indicators for each radio link and resources available via each radio link; form a list of available radio links based on the key performance indicators and available resources, where the list of available radio links are those present on the second access point; receive a request for at least one additional radio link from the non-AP MLD device; and send the list of available radio links to the non-AP MLD device, where the non-AP MLD device selects at least one additional radio link and makes a connection using the at least one additional radio link on the second access point.

Yet, another embodiment presented in the disclosure is a non-transitory computer-readable medium encoding instructions, which, when executed by a processor of a first access point coupled to a wireless medium, cause the first access point to: establish a connection using a radio link between the first access point and a non-AP MLD device; obtain a set of indicators for a plurality of radio links, wherein the set of indicators includes key performance indicators for each radio link and resources available via each radio link, form a list of available radio links based on the key performance indicators and available resources, where the list of available radio links are those present on a second access point; receive a request for at least one additional radio link from a non-AP MLD device; and send the list of available radio links to the non-AP MLD device, where the non-AP MLD device selects at least one additional radio link and makes a connection using the at least one available radio link on the second access point.

### EXAMPLE EMBODIMENTS

This disclosure describes a method that allows the primary connection holder (first AP device) to guide and update the non-AP MLD about the best available additional radio links.

A non-AP MLD can often improve its performance by adding another radio link to its existing radio links. However, some available radio links may not provide the performance boost that the non-AP MLD desires (or may provide sub-optimal improvement). In some embodiments, to help the non-AP MLD choose a link that maximally improves its performance (or is most likely to improve the performance), the non-AP MLD can make a request (optionally specifying its requirements) to the AP with which it is currently associated, asking the AP to provide a list of acceptable or alternative links. The request and/or response may specify a set of links sorted and/or filtered by various performance parameters, such as throughput and jitter, or a pair of links that provide a high level of throughput when used together. In an embodiment, the AP then provides the list to the non-AP MLD, and the non-AP MLD can then choose the link best suited to its requirements in order to set up an additional/alternative link (to the same AP or to a different AP).

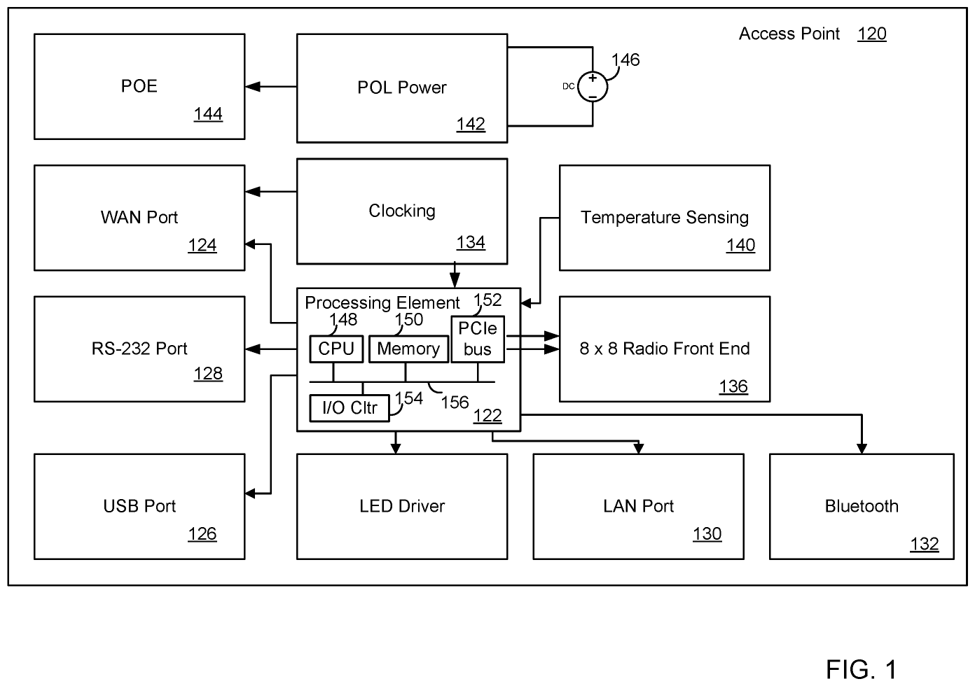

FIG. 1 depicts a representative architecture of an access point. The AP 120 includes a processing element 122 and several ports or connection facilities, such as a WAN port 124, USB port 126, RS-232 port 128, LAN port 130, and Bluetooth 132. Also included are a clocking system 134 and an 8×8 radio front-end 136 with a transmitter and receiver, which are coupled to internal or external antennas. Auxiliary modules include a temperature sensing module 140, a power module 142 connected to a DC power source 146, and a power over Ethernet (POE) module 144. The processing system includes a CPU 148 and memory 150, a peripheral component interconnect express (PCIe) bus controller 152 for connecting to the radio front-end 136, and an I/O controller 154, all coupled to each other via bus 156.

The AP implements the physical layer of the 802.11 specification, adding two new features to the wireless protocol: multi-user multiple-input, multiple output (MU-MIMO) radio links, and orthogonal frequency division multiple access (OFDMA).

MU-MIMO allows parallelism in the spatial domain. In MU-MIMO, multiple transmitters and receivers can operate simultaneously during the same transmission opportunity (TXOP). MU-MIMO supports up to 8 simultaneous transmissions and is well-suited to large data packets.

OFDMA allows parallelism within a channel primarily for smaller data packets. In OFDMA, the spectrum is organized into a set of operating channels. Each channel comprises subcarriers, with some of the subcarriers used as pilot carriers and the others for carrying data. Each subcarrier is quadrature amplitude modulation (QAM) modulated. In addition, the subcarriers of a channel are assigned to groups called resource units (RUs), which can be operated independently of each other. Thus, a 20 MHz channel can support communication between a single station or client or among up to nine stations or clients simultaneously, each having its own RU. The number of simultaneous transmissions can vary per TXOP.

To handle the new capabilities of OFDMA and MU-MIMO, a number of new physical layer data frames and medium access control (MAC) layer control frames are included in the protocol standard. The MAC layer control frames include trigger frames which are used to schedule uplink and downlink multi-user transmissions.

In the illustrated embodiment, the AP 120 may participate or facilitate assisted multi-link guidance, as discussed above. For example, the AP 120 may receive guidance requests from client devices (e.g., one or more frames requesting information about alternative links). Such requests may indicate a generic desire or need for more performance or services or may indicate specific preferences and/or needs of the client.

In response, in the illustrated example, the AP 120 may access and/or generate and return a list of alternative links, as discussed above and in more detail below. When returned to the client device, this response enables the client to intelligently select one or more alternative links to establish additional connections (to the AP 120 or another AP). In this way, the depicted AP 120 can significantly improve the operations and efficiency of the client device(s) and the overall network.

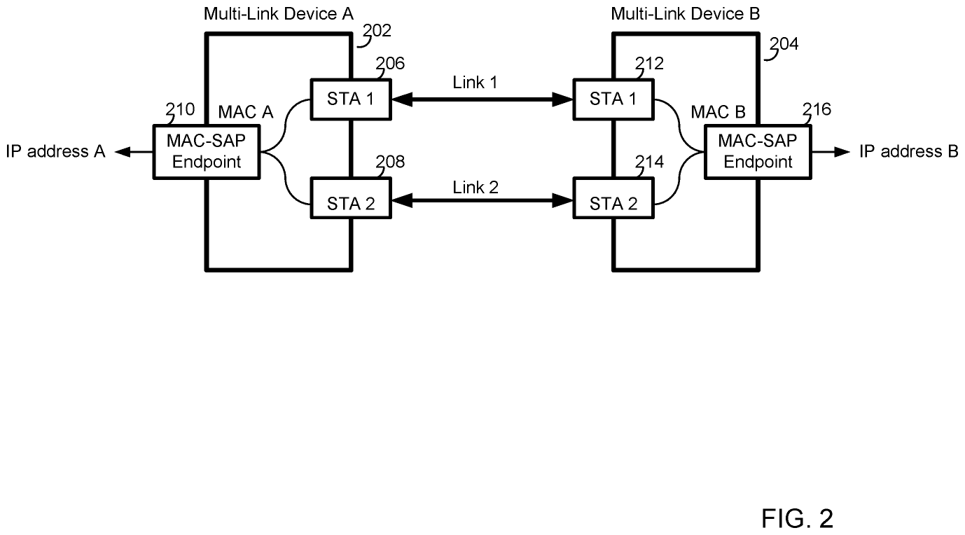

FIG. 2 depicts two multi-link devices communicating over multiple radio links, in an embodiment. It is desirable to have a multi-link device (MLD) A 202 able to select the radio links to connect with MLD B 204. Thus, MLD A 202, with a single medium access layer service access point (MAC-SAP) endpoint A 210, has two radio links, STA 1 206 and STA 2 208, while MLD B, with a single MAC-SAP endpoint B 216, has two radio links, STA 1 212 and STA 2 214 which it has selected to connect to the radio links STA 1 206 and STA 2 208 in MLD A 202. In the figure, MLD A may be an access point, and MLD B may be a non-AP station. In an embodiment, MLD A provides guidance to MLD B in the form of a list of links acceptable to parameters in a request by MLD B to select one of the radio links STA 1 206 or STA 2 208. It should be noted that, though only two links are depicted in each MLD, each MLD can request additional guidance and select one or additional links for communication between each other.

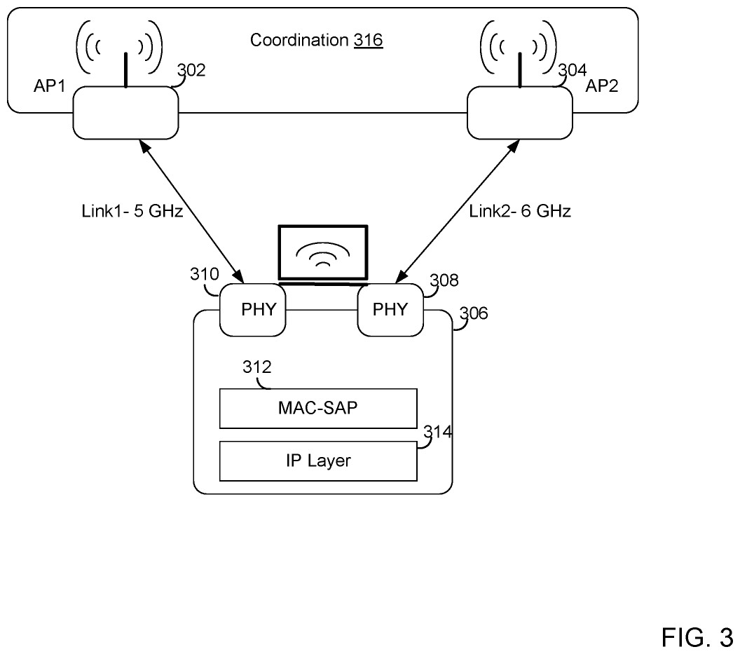

FIG. 3 depicts two APs coordinating with each other, in an embodiment. In the figure, MLD may be a non-AP MLD, such as a multi-link handheld user device having link 308 and link 310 (or having the capability to use link 308 and/or link 310). In the depicted example, non-AP MLD 306 may use a link from AP 1 302 (e.g., the 5 GHz link 310 to AP 1 302) as its primary link, where the primary link is the link between the primary MLD and the non-AP MLD on which the non-AP MLD relies for communication to the primary AP MLD even if there are other AP MLDs. In the illustrated example, the non-AP MLD 306 may determine to instantiate and/or use an additional link (e.g., link 308 to AP 2 304),In some embodiments, as discussed above and in more detail below, the non-AP MLD 306 determines to use the second link 308 based on requesting and reviewing a list of available/alternative links (e.g., provided by AP 1 and/or AP 2). For example, the non-AP MLD 306 may use its primary link (e.g., link 310) to AP 1 302 to request such a list of alternative links. In response, the list may be sent to the non-AP MLD 306, which includes a MAC layer 312 and a network or IP layer 314. In an embodiment, the non-AP MLD 306 can select one or more links from among the available links that meet the preferences or requirements of the non-AP MLD 306 (which the non-AP MLD 306 may have indicated to the AP in the request). In some embodiments, the APs(e.g., AP 1 302 and AP 2 304) provide such guidance to non-AP MLD 306 in the form of a list of links by exchanging performance and resource information with each other.

That is, AP 1 302 and AP 2 304 may share information relating to the performance indicators of their respective available links (e.g., throughput, jitter, and the like) with each other (as indicated by coordination 316). This coordination 316 may be performed at various times, including periodically doing so prior to receiving a link request from a client (e.g., prior to the non-AP MLD 306 requesting the set of alternative links) or in response to receiving such a link request. That is, the APs may share and/or maintain link performance information ahead of time in order to enable any to respond to requesting clients, or the APs may share or request the link performance when such a request is received.

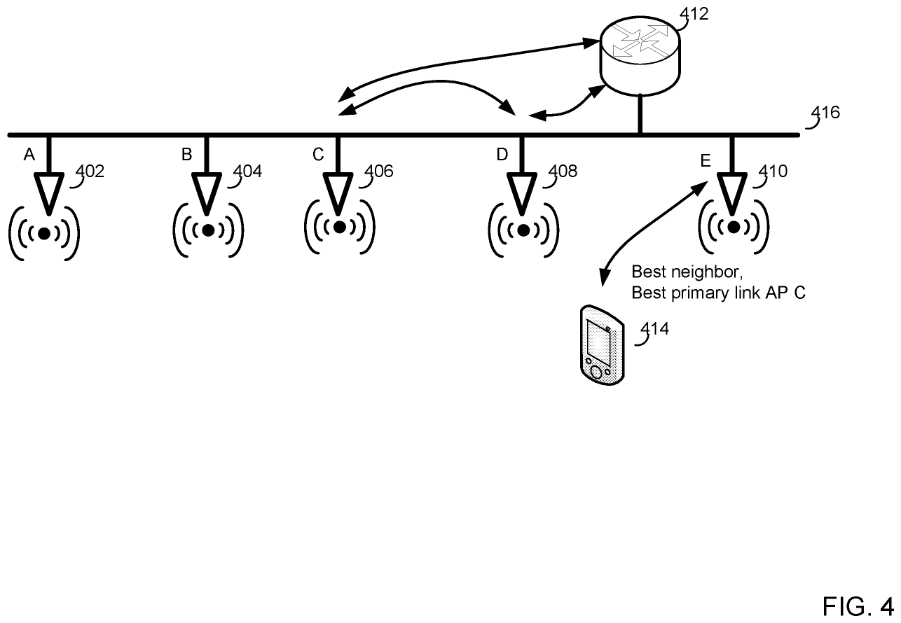

FIG. 4 depicts two APs coordinating with each other, in an embodiment. In the figure, APs 402, 404, 406, 408, 410 are coupled to a wired network 416. In an embodiment, after the APs 402, 404, 406, 408, 410 exchanges messages (including or requesting performance indicators for the potential or available links)with each other (e.g., via the wired network 416), the APs 402, 404, 406, 408, 410 may jointly or independently create a list of available links and associated resources, such as access via router 412. As discussed above, these list(s) may be created according to various criteria, including periodically (e.g., daily or hourly) or in response to receiving a request from a non-AP MLD. In an embodiment, the AP that receives such a request can then send the list of available links and/or associated resources to the requesting non-AP MLD 414. The non-AP MLD414 can then select the link(s), such as one from AP E 410, most suited to its requests or preferences.

Primary Device Flow

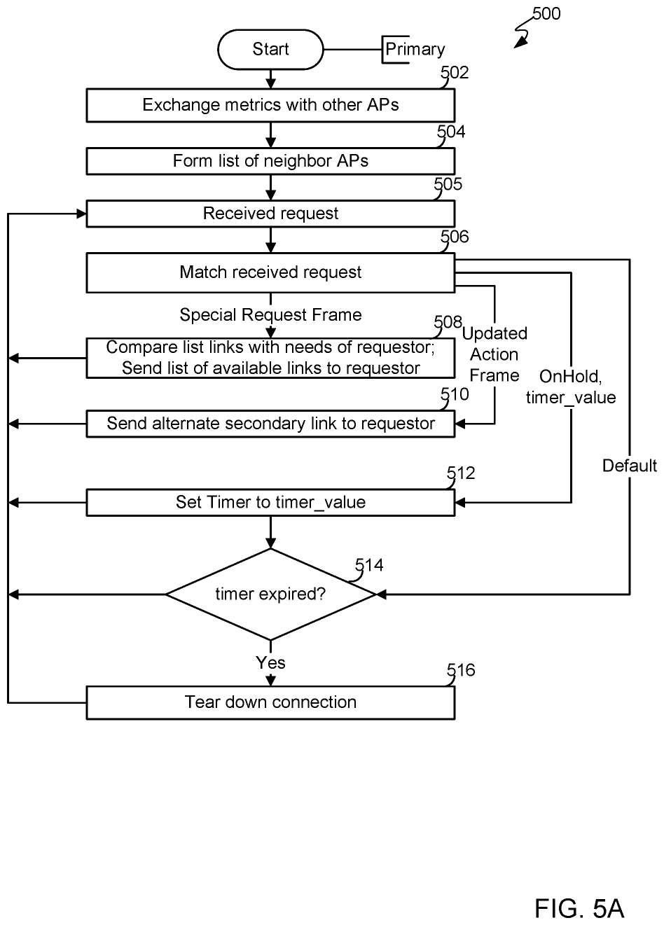

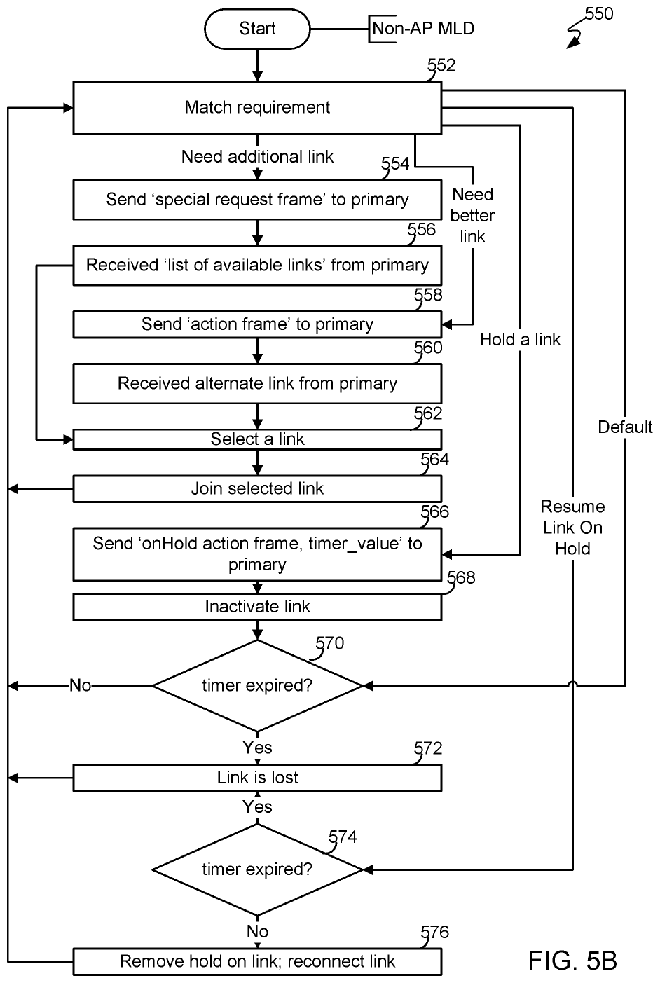

FIG. 5A depicts a flow of operations for a primary multi-link device, in an embodiment, where a primary MLD is one to which a non-AP MLD is connected and services as its access to the wireless network, even if other APs are present. FIG. 5B depicts a flow of operations of a non-AP client in FIGS. 3 and 4, in an embodiment.

At block 502, each IEEE mMLD AP (i.e., IEEE 802.11be multi-link device) exchanges performance metrics with its neighbor. For example, each IEEE mMLD AP shares with other IEEE mMLD APs key performance indicators (KPIs), also referred to as performance characteristics, such as Basic Service Set (BSS) Load (including client count, channel utilization CU, available schedulable time etc.), mean delay and jitter, retry rate etc., in addition to capability (mMLD support. These elements can be shared through over-the-air neighbor discovery protocol (NDP) messages or over the wired distribution system (DS) (e.g., through a wired LAN controller (WLC) connecting the APs).

At block 504, each IEEE mMLD AP forms a list of neighbors (and the AP device collects these lists from each IEEE AP [radio and band] hosted in the AP device). In one embodiment, each AP device sorts the list of neighbors by criteria (latency, CU, availability etc.). In one embodiment, this list is established in advance and at intervals. In another embodiment, the list is built in response to a client query.

At block 505, the primary device receives one of several requests from the client device, where ‘received’ is a blocking operation in that the flow waits until an item (e.g., the request) is received. The requests include a ‘special frame request,’ an ‘updated action frame,’ and an ‘OnHold request.’ Although block 505 is described as a blocking operation in some embodiments, it is to be understood that block 505 merely corresponds to the AP receiving a client request prior to performing one or more blocks of method 500 and does not imply or require that the AP cease any other operations until the request is received.

At block 506, the primary device matches one of several requests from the client device. Otherwise, the primary defaults to periodically checking whether a timer that may have been set has expired.

When the non-AP MLD client needs to initiate another connection, it sends a ‘special request frame’ to the primary IEEE mMLD AP, which causes the transition to block 508. In some embodiments, the ‘special request frame’ contains the needs of the non-AP MLD client, such as lower latency, higher throughput, or more frequent scheduling.

In one embodiment, the frame is a modified 802.11k neighbor report request that includes traffic descriptors for the second links (e.g., target traffic on the current interface that needs to be extended to a second interface, with the goal [e.g., latency reduction], new traffic that needs to be added (e.g., FastLane Plus (FL+), Stream Classification Service (SCS) descriptor or other), etc. The descriptor may include over-the-air performance requirements.

In some embodiments, the non-AP MLD expresses a sort preference for the list (e.g., ‘lowest latency neighbors’). In some embodiments, the non-AP MLD queries the IEEE mMLD AP about one or more specific neighbors (for example, because the non-AP STA discovered these neighbors in a previous scan).

In some embodiments, in addition to or instead of receiving the request or preference(s) from the client device, a central management system like a Network Controller/Wireless LAN Controller may maintain details about the client (non-AP MLD) profile and traffic history. For example, Manufacturer Usage Description (MUD) could be used (e.g., in the case of Internet of things (IoT) devices) or Device profiling from a RADIUS service or a client database server, and/or deep packet inspection for application recognition may be used. In short, the traffic may be qualified or provided from a management entity in addition to or instead of being shared by the non-AP MLD client in the modified action frame or possibly a special request frame.

At block 508, the primary IEEE mMLD AP compares the list of available neighboring mMLD APs information with the (indicated or inferred) requirements of the non-AP MLD client and sends a sorted and/or a filtered list of IEEE mMLD APs (i.e., the list is sorted by BSSIDs and/or some BSSIDs are removed from the list)as per traffic performance and client request) so that the non-AP MLD client can initiate the secondary MLD link connection based on the described traffic requirements. In some embodiments, the primary IEEE mMLD AP returns a labeled but unsorted and/or unfiltered list of IEEE mMLD AP neighbors and their KPI, allowing the client to sort the list based on its requirements.

As the non-AP MLD client establishes traffic flow through the second IEEE mMLD AP, the client may determine whether the resources allocated on the second IEEE mMLD AP are sufficient (e.g., whether the resources meet or do not meet its requirements). In one such embodiment, if the client determines that the allocated resources on the second mMLD AP are insufficient, the client can then send one or more frames, such as an ‘updated action frame,’ to the primary IEEE mMLD AP, describing the unfulfilled requirement (e.g., more frequent scheduling, lower latency, etc.). Upon receipt of the ‘updated action frame,’ the Primary IEEE mMLD AP can then suggest, in block 510, an alternate secondary IEEE mMLD AP, if available. This message may be a modified 802.11k neighbor report or a modified 802.11v BSS Transition message (BTM).

At any time, the non-AP MLD client may elect the current secondary IEEE mMLD AP as its new primary IEEE mMLD AP and use this method to find an alternate link to the previous primary IEEE mMLD AP.

A non-AP MLD client may decide to shut down a link temporarily. To do so, the primary mMLD AP receives, in block 506, an ‘onHold request’ with a timer value. In response to the conHold request,′ the primary mMLD AP sets a time to the timer value in block 512. If the IEEE mMLD AP does not hear from the client at the end of the set time period, as determined in block 514, it tears down the connection in block 516, and the client needs to re-establish the link.

Thus, the above methods and systems allow sharing with a non-APMLD client that requires establishing a second MLD link, a list of IEEE mMLD AP neighbors, so that the non-AP MLD client can pick up another link based on its traffic requirements.

Non-AP Client Device Flow

A non-AP MLD client may require multiple connections due to various types of requirements—load balancing (connection robustness), latency reduction, reliability (make before break), etc. Now referring to FIG. 5B, which describes the non-AP client device method 550, in block 552, the non-AP client matches its requirement to one of several requests it can make, including a ‘special request frame’ for an additional link, can action frame′ for a better link, and an ‘onHold request’ to hold a link in safe custody.

In block 554, if the non-AP MLD/client determines that it requires an additional link, the non-AP client sends a ‘special request frame’ to its current primary MLD. In response, in block 556, the client has received a list of available links from the primary MLD, where block 556 is a blocking operation in which the non-AP MLD waits for the list. Although block 556 is described as a blocking operation in some embodiments, it is to be understood that block 556 merely corresponds to the non-AP MLD receiving a client request prior to performing one or more blocks of method 550, and does not imply or require that the non-AP cease any other operations until the list is received.

For example, as discussed above, with reference to FIG. 5A, the AP MLD may exchange metrics and/or generate and return the list of alternative links (e.g., at block 508).

In block 558, the non-AP client sends an ‘action frame’ to its current primary MLD if the non-AP client desires a better link because the links in the current list are insufficient. In response to the primary MLD, the non-AP client received in block 560 an alternate link from the primary MLD in response to step 510 of FIG. 5A, where block 560 is a blocking operation in which the non-AP client waits for receipt of the alternate link. Although block 558 is described as a blocking operation in some embodiments, it is to be understood that block 558 merely corresponds to the non-AP MLD receiving a client request prior to performing one or more blocks of method 550, and does not imply or require that the non-AP cease any other operations until the list is received.

In block 562, after receiving a list of available links in block 556 or receiving an alternate link from the current primary MLD in block 560, the non-AP client selects a particular link in block 562 and joins the selected link in the IEEE mMLD AP (BSSID) in block 564, after which control returns to block 552 to process the next requirement.

In some embodiments, the non-AP client may also keep one of the MLO connections on hold in a safe custody mode. That is, at block 552, the non-AP client may determine XYZ. This mode can use an inverted BSS Max Idle timer (and thus can augment wireless network management (WNM)-Sleep Mode).

Thus, if a non-AP MLD client does not currently need the secondary and tertiary connection for some time, in block 566, it sends an ‘On Hold’ action frame with a specified timer value to the relevant IEEE mMLD AP (primary or secondary).

In block 568, the client then inactivates the associated radio link. This differs from WNM-Sleep Mode, where the STA merely signals entering sleep mode with no target exit time. This is also different from target wake time (TWT), as it is not schedule-based and intends to keep the connection state alive for a specific duration and saves the process of MLO teardown and establishment.

In block 570, the client determines in response to a period default operation whether the time for the hold has expired. If not, the non-AP client may renew the hold by sending another conHold action frame′ with a new timer value (e.g., return to 552, decide to send conHold,′ and go to 566 again). If the time has expired, the non-AP client loses the link in block 572.

If the timer for the link has not expired, as determined in block 574 in response to ‘resume link on hold,’ the client removes the hold and joins the link again in block 576.

Multiple AP Multi-link Devices

In a single AP setting(such as described above), each AP radio announces the overall AP MLD, allowing scanning STAs to recognize that both radios, although having different MAC/BSSID values, they are part of the same MLD group/system (management frames are also envisioned to share information on each link about the other link in the MLD).

Coordination is more complex with the multi-AP scenario. Many different neighboring APs/radio combinations could be used for a multi-link setup with a given STA in a multi-AP scenario. Yet, all APs and all radios would be announcing the same MLD value, offering to the STA an indiscriminate sea of radios to choose from, without any information on which pairing would improve or degrade the application experience. To properly support inter-AP MLD in future Wi-Fi standards, it may be beneficial to provide guidance to the STA on which next radio to choose for another link.

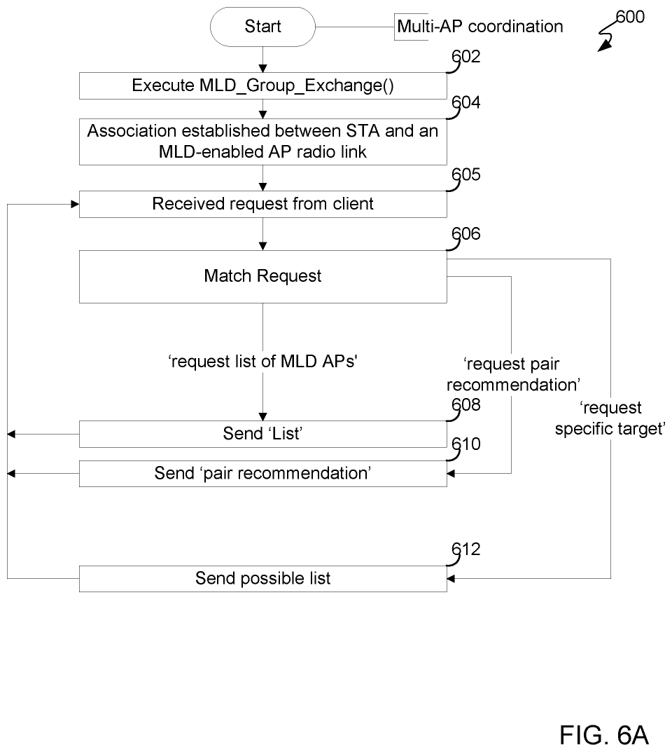

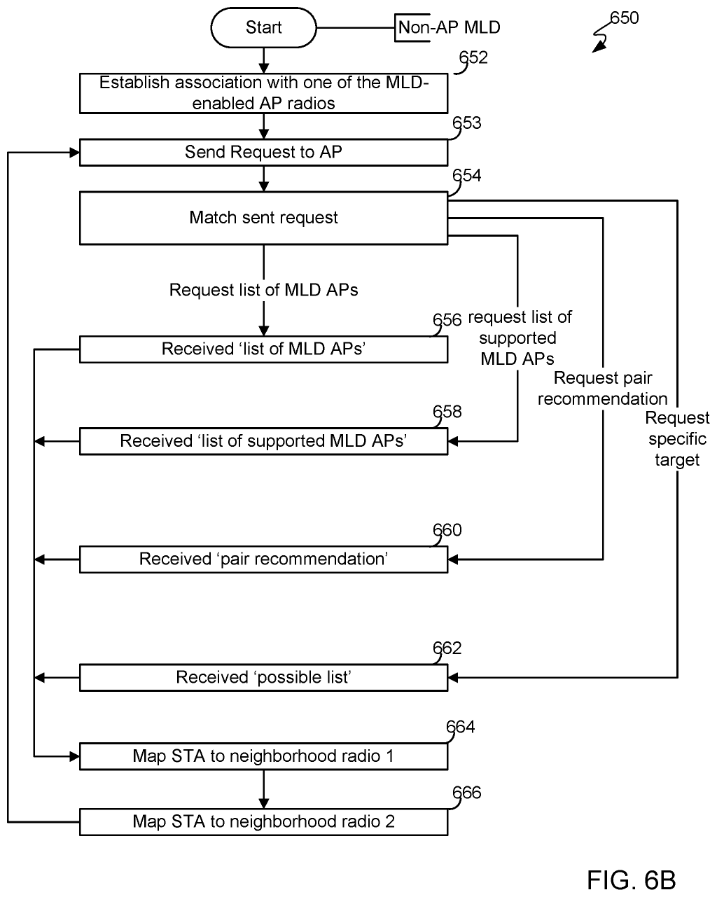

FIG. 6A depicts a flow of operations for multi-AP MLD coordination, in an embodiment.

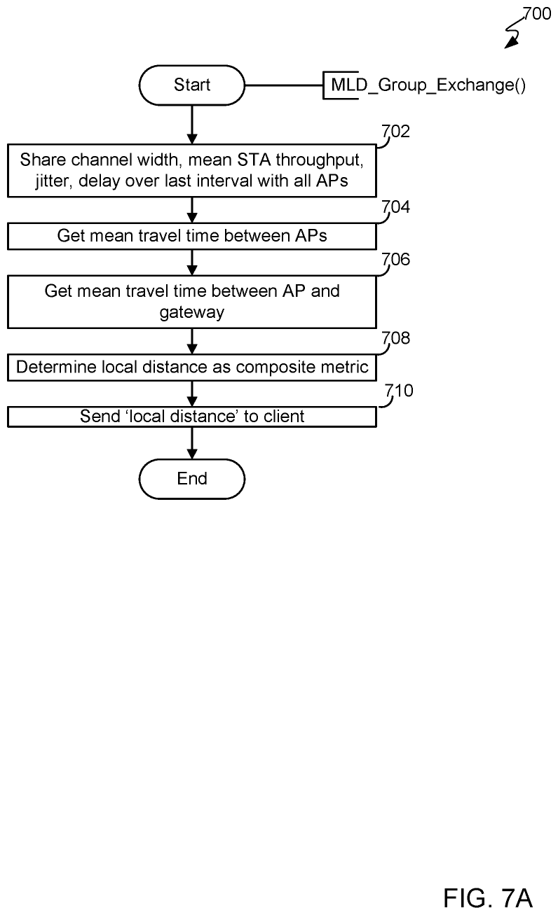

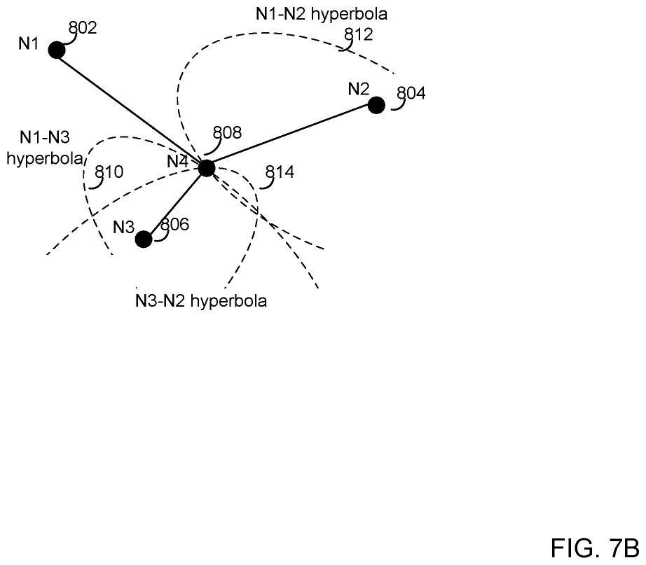

In block 602 of method600, the multi-link AP executes an MLD_Group_Exchange function which results in a composite local distance metric, further described below with reference to FIG. 7.

In block 604, an association is established between non-AP MLD and an MLD-enabled AP radio link.

In block 605, the AP receives a request from a non-AP MLD. The receiving operation is blocking, with the flow stopped at block 605, awaiting a request. Although block 605 is described as a blocking operation in some embodiments, it is to be understood that block 605 merely corresponds to the AP receiving a client request prior to performing one or more blocks of method 600, and does not imply or require that the AP cease any other operations until the request is received.

In block 606, the AP matches a request with one of several possible requests, including a ‘request a list of MLD APs,’ request a pair recommendation,′ and ‘request a specific target’ from a non-AP MLD.

In block 608, if the AP receives a request for a list of MLD-APs (or of links on one or more MLD APs) with radio links matching the requirements of the requestor, the AP sends a list to the requestor. In some embodiments, the request may simply indicate the desire for an additional link without specifying any specific requirements of the requestor.

In block 610, if the AP receives a request for a pair recommendation (e.g., a pair or set of links that jointly satisfy the request), the AP sends a pair recommendation to the non-AP MLD, where a pair recommendation contains two selected links that together meet the requirements of the requestor.

In block 612, if the AP receives a request for a specific target (e.g., a link meeting specified target criteria or performance), the AP sends a possible list to the non-AP MLD, where a specific target is a link of a particular AP that meets the requested requirement.

FIG. 6B depicts a flow of operations for a non-AP MLD, in an embodiment.

At block 652 of method 650, a client establishes an association with a first MLD-enabled AP radio.

At block 653, the client sends a request to the AP. The request is one of a request a list of MLD APs′, ‘request a list of supported MLD APs,’ request a pair recommendation,′ and ‘request a specific target.’

At block 654, the non-AP MLD matches the request to one of the several requests that was sent.

At block 656, in response to ‘request a list of MLD APs,’ the non-AP MLD receives a list of neighboring AP radios supporting MLD operations from the AP, where again, the receiving block is blocking and thus waits for the list to arrive. Although block 656 is described as a blocking operation in some embodiments, it is to be understood that block 656 merely corresponds to the non-AP receiving a list prior to performing one or more blocks of method650, and does not imply or require that the non-AP MLD cease any other operations until the request is received.

In one embodiment, the list is a modified solicited or unsolicited 802.11k neighbor report (i.e., this can be an extension to 802.11k), where the neighbor report contains an element ID, a length, a BSS ID, BSS ID information, operating class, channel number, and PHY type. Each neighbor AP radio may also be assigned a local proximity value (described below) based on mean throughput, jitter, and delay values.

At block 658, in response to ‘request a list of supported MLD APs,’ the client receives a list of supported MLD APs (i.e., those that conform to IEEE 802.11be). The non-AP MLD can query for a list of supported MLD APs before or during the association. In the case of pre-association, MLD capabilities are advertised using a PreAssociation Discovery (PAD) element (i.e., a series of pre-association question/responses defined in 802.11aq) through Access Network Query Protocol (ANQP)/802.11aq. The client obtains recent values about neighboring APs that can be used to establish another link each time.

At block 660, in response to ‘request a pair recommendation,’ the client receives a pair recommendation. In this case, the non-AP MLD may not conclude that it should associate with one of the AP radios but attempts to connect two links in the most efficient way.

At block 662, in response to ‘request a specific target’ and thus requests and receives a list of possible targets. When such a request is made, the STA queries for a specific target (e.g., a request to send suggested pairs sorted by shortest distance or highest throughput, etc.). Based on the STA signal, the AP responds with a list of possible targets.

In block 664, the non-AP MLD associates with a first radio link, and in block 666, a second radio link is based on the information received from one of its previous requests.

FIG. 7A depicts a flow of operations for a multi-link device (MLD) group exchange function, in an embodiment.

[ono] Recalling that at block 602 of FIG. 6A, as the STA establishes connections to two neighboring radios, traffic reordering and IP addressing may dictate that the STA traffic should exit a single point onto the network, where the STA appears with a single MAC and IP address, and sends ordered packets. A primary AP can be designated, and traffic flowing through the secondary AP may be first tunneled to the first AP before being sent upstream. Thus, the MLD group exchanges packets in advance according to blocks 702-710 of FIG. 7A.

In block 702 of method 700, the APs, which coordinate with each other, can also share information such as their channel width (possibly via a WLC) and mean STA throughput, jitter and/or a delay value over a past interval (e.g., 90 s).

In block 704, the APs establish the mean travel time between APs.

In block 706, the APs establish the mean travel time between the APs and a local gateway in the STA VLAN, where the local gateway is a router that couples the network on which the APs reside to the VLAN on which the station STA resides.

In block 708, the APs establish a local distance metric as a composite metric derived from the mean travel time between APs in step 704 and the mean travel time between APs and a gateway in step 706. In one embodiment, a center point is established as the STA seeking the composite metric, as depicted in FIG. 7B.

In FIG. 7B, node N1 802, node N2 804 and node N3 806 are 802.11be APs (or a local gateway) and node N4 808 is a MLD STA. For each pair of APs, hyperbolas (N1-N3 810, N1-N2 812, N3-N2 814) are defined for a line connecting each element of the pair as the main axis of the hyperbola and each element as a focus. All hyperbolas (N1-N3 810, N1-N2 812, N3-N2 814), so constructed, intersect at node N4 808. The composite metric for a pair (e.g., N1-N2) is the distance between the STA 808 and a point on the hyperbola 812 for the pair.

Referring back to FIG. 7A, in block 710, the APs send the local distance metric to the non-AP MLD, where the local distance represents the mean delay to the gateway when using the local AP and the target neighbor (weighted by the relative throughput of both AP radios).

In sum, MLO allows an STA to establish links to multiple BSSIDs. However, IP operation mandates a single point of presence (PoP), thus a single IP seen on a single link. The method above designates this best exit point based on each AP wireless and wired KPIs and a method to share this recommendation with the non-AP MLD. As future Wi-Fi standards expand MLO to inter-AP, such a method is especially useful to avoid breaking upper-layer functionalities (or causing performance degradations).

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer-readable medium(s) having computer-readable program code embodied thereon.

Program code embodied on a computer-readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer-readable medium that can direct a computer, other programmable data processing apparatus, or other device to function in a particular manner, such that the instructions stored in the computer-readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational blocks to be performed on the computer, other programmable apparatus or other device to produce a computer-implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method of aiding selection of at least one additional radio link, the method comprising:
establishing a connection using a radio link between a first access point and a non-AP MLD device;
obtaining a set of indicators for a plurality of radio links, wherein the set of indicators includes key performance indicators for each radio link and resources available via each radio link;
forming a list of available radio links based on the key performance indicators and available resources, the list of available radio links being those present on a second access point;
receiving a request for the at least one additional radio link from the non-AP MLD device; and
sending the list of available radio links to the non-AP MLD device, wherein the non-AP MLD device selects at least one additional radio link and makes a connection using the at least one additional radio link on the second access point.

2. The method of claim 1, wherein forming the list of available radio links includes executing a function in which the first access point and the second access point exchange information regarding performance characteristics of each access point.

3. The method of claim 2, wherein the performance characteristics include a channel width, jitter, and a delay encountered over a time interval.

4. The method of claim 2, wherein the performance characteristics include a local distance metric based on mean travel time between the first and second access points and between the first and second access points and a gateway connected to the first and second access points.

5. The method of claim 1,
wherein the non-AP MLD device specifies a set of requirements in the request; and
wherein forming the list of available radio links includes sorting the list of available radio links according to the set of requirements.

6. The method of claim 1, further comprising:
receiving an action frame from the non-AP MLD device, the action frame indicating that the list of available radio links is insufficient for the non-AP MLD device; and
sending an alternate available radio link to the non-AP MLD device.

7. The method of claim 1, wherein the available resources include a router coupled via a wired network to the first access point and the second access point.

8. A system for aiding selection of at least one additional radio link, the system comprising:
a first access point having multiple radio links;
a second access point having multiple radio links and coupled to the first access point; and
a non-AP MLD device having multiple radio links and coupled to the first access point and the second access point;
wherein the first access point is configured to:
establish a connection using a radio link of the first access point and the non-AP MLD device;
obtain a set of indicators for a plurality of radio links, wherein the set of indicators includes key performance indicators for each radio link and resources available via each radio link;
form a list of available radio links based on the key performance indicators and available resources, the list of available radio links being those present on the second access point;
receive a request for the at least one additional radio link from the non-AP MLD device; and
send the list of available radio links to the non-AP MLD device, wherein the non-AP MLD device selects the at least one additional radio link and makes a connection using the at least one additional radio link on the second access point.

9. The system of claim 8, wherein being configured to form the list of available radio links includes being configured to execute a function in which the first access point and the second access point exchange information regarding performance characteristics of each access point.

10. The system of claim 9, wherein the performance characteristics include a channel width, jitter, and a delay encountered over a time interval.

11. The system of claim 9, wherein the performance characteristics include a local distance metric based on mean travel time between the first and second access points and between the first and second access points and a gateway connected to the first and second access points.

12. The system of claim 8,
wherein the non-AP MLD device specifies a set of requirements in the request; and
wherein forming the list of available radio links includes sorting the list of available radio links according to the set of requirements.

13. The system of claim 8, wherein the first access point is further configured to:
receive an action frame from the non-AP MLD device,
the action frame indicating that the list of available radio links is insufficient for the non-AP MLD device; and
send an alternate available radio link to the non-AP MLD device.

14. The system of claim 8, wherein the available resources include a router coupled via a wired network to the first access point and the second access point.

15. A non-transitory computer-readable medium encoding instructions, which, when executed by a processor of a first access point coupled to a wireless medium, cause the first access point to:
establish a connection using a radio link between the first access point and a non-AP MLD device;
obtain a set of indicators for a plurality of radio links, wherein the set of indicators includes key performance indicators for each radio link and resources available via each radio link;
form a list of available radio links based on the key performance indicators and available resources, the list of available radio links being those present on a second access point;
receive a request for at least one additional radio link from the non-AP MLD device; and
send the list of available radio links to the non-AP MLD device, wherein the non-AP MLD device selects the at least one additional radio link and makes a connection using the at least one additional radio link on the second access point.

16. The non-transitory computer-readable medium of claim 15, wherein the first access point forms the list of available radio links by executing a function in which the first access point and the second access point exchange information regarding performance characteristics of each access point.

17. The non-transitory computer-readable medium of claim 16, wherein the performance characteristics include a channel width, jitter, and a delay encountered over a time interval.

18. The non-transitory computer-readable medium of claim 16, wherein the performance characteristics include a local distance metric based on mean travel time between the first and second access points and between the first and second access points and a gateway connected to the first and second access points.

19. The non-transitory computer-readable medium of claim 15,
wherein the non-AP MLD device specifies a set of requirements in the request; and
wherein the instructions causing the first access point to form the list of available radio links include instructions to cause sorting of the list of available radio links according to the set of requirements.

20. The non-transitory computer-readable medium of claim 15, wherein the instructions further cause the first access point to:
receive an action frame from the non-AP MLD device, the action frame indicating that the list of available radio links is insufficient for the non-AP MLD device; and
send an alternate available radio link to the non-AP MLD device.
